(19) United States
(12) Patent Application Publication
(10) Pub. No.: US 2024/0192525 A1
(43) Pub. Date: Jun. 13, 2024

(54) Sunglasses with near-vision adjustment

(71) Applicant: OPTICA AMUKA (A.A.) LTD., Petach Tikva (IL)

(72) Inventors: Yoav Yadin, Ganey Tikva (IL); Alex Alon, Binyamina (IL); Yariv Haddad, Raanana (IL); Aviezer Ben-Eliyahu, Zur-Hadassa (IL); Itamar Haim Grutman, Mazkeret Batya (IL); Alon Shoavi, Herzliya (IL); David Lichterov, Ramat Gan (IL); Orel Bechler, Rehovot (IL)

(21) Appl. No.: 18/548,932

(22) PCT Filed: Mar. 28, 2022
(86) PCT No.: PCT/IB2022/052812

§ 371 Date: Sep. 5, 2023

Related U.S. Application Data
(60) Provisional application No. 63/167,124, filed on Mar. 29, 2021.

(51) Int. Cl. G02C 7/08; G02B 3/14; G02B 26/00; G02F 1/1343; G02F 1/29

(52) U.S. Cl. CPC G02C 7/083; G02B 3/14; G02B 26/004; G02F 1/134309; G02F 1/294

(57) ABSTRACT

Adaptive spectacles (20) include a frame (23), including a front piece (24) and temples (26) connected to respective edges of the front piece. Right and left electrically tunable lenses (30) are mounted in the front piece. Communication circuitry (68) disposed in the frame is configured to communicate over a wireless link with a mobile computing device (32) in proximity to the adaptive spectacles. Control circuitry (64) disposed in the frame is configured to apply control voltage waveforms to the electrically tunable lenses in order to set a refractive property of the electrically tunable lenses and to modify the control voltage waveforms in response to a command received over the wireless link by the communication circuitry from the mobile computing device.

### CROSS-REFERENCE TO RELATED APPLICATION

This application claims the benefit of U.S. Provisional Patent Application 63/167,124, filed Mar. 29, 2021, which is incorporated herein by reference.

### FIELD OF THE INVENTION

The present invention relates generally to optical devices, and particularly to electrically-tunable spectacles.

### BACKGROUND

Tunable lenses are optical elements whose optical characteristics, such as the focal length and/or the location of the optical axis, can be adjusted during use, typically under electronic control. Such lenses may be used in a wide variety of applications, such as in spectacles for vision correction and for augmented and virtual reality.

Electrically tunable lenses typically contain a thin layer of a suitable electro-optical material, i.e., a material whose local effective index of refraction changes as a function of the voltage applied across the material. An electrode or array of electrodes is used to apply the desired voltages in order to locally adjust the refractive index to the desired value. Liquid crystals are the electro-optical material that is most commonly used for this purpose (wherein the applied voltage rotates the molecules, which changes the axis of birefringence and thus changes the effective refractive index), but other materials, such as polymer gels, with similar electro-optical properties can alternatively be used for this purpose.

Some tunable lens designs use an electrode array to define a grid of pixels in the liquid crystal, similar to the sort of pixel grid used in liquid-crystal displays. The refractive indices of the individual pixels may be electrically controlled to give a desired phase modulation profile. (The term “phase modulation profile” is used in the present description and in the claims to mean the distribution of the local phase shifts that are applied to light passing through the layer as the result of the locally-variable effective refractive index over the area of the electro-optical layer of the tunable lens, relative to the phase shift that is applied to light passing through the layer when no electrical power is applied.) Lenses using grid arrays of this sort are described, for example, in U.S. Pat. No. 7,475,985.

PCT International Publication WO 2014/049577, whose disclosure is incorporated herein by reference, describes an optical device comprising an electro-optical layer, having an effective local index of refraction at any given location within an active area of the electro-optical layer that is determined by a voltage waveform applied across the electro-optical layer at the location. An array of excitation electrodes, including parallel conductive stripes extending over the active area, is disposed over one or both sides of the electro-optical layer. Control circuitry applies respective control voltage waveforms to the excitation electrodes and is configured to concurrently modify the respective control voltage waveforms applied to excitation electrodes so as to generate a specified phase modulation profile in the electro-optical layer.

PCT International Publication WO 2017/182906, whose disclosure is incorporated herein by reference, describes an optical device, including an electro-optical layer and conductive electrodes disposed over opposing first and second side of the electro-optical layer. Control circuitry applies control voltage waveforms between the conductive electrodes so as to generate a phase modulation profile in the electro-optical layer that causes rays of optical radiation that are incident on the device to converge or diverge with a given focal power, while varying an amplitude of the control voltage waveforms for the given focal power responsively to an angle of incidence of the rays that impinge on the device from a direction of interest.

PCT International Publication WO 2015/186010, whose disclosure is incorporated herein by reference, describes adaptive spectacles, which include a spectacle frame and first and second electrically-tunable lenses, mounted in the spectacle frame. In one embodiment, control circuitry is configured to receive an input indicative of a distance from an eye of a person wearing the spectacles to an object viewed by the person, and to tune the first and second lenses in response to the input. Other types of electrically tunable lenses and aspects of their operation are described in PCT International Publication WO 2017/216716, whose disclosure is likewise incorporated herein by reference.

### SUMMARY

Embodiments of the present invention that are described hereinbelow provide improved adaptive spectacles and methods for their production and operation.

There is therefore provided, in accordance with an embodiment of the invention, an electrically tunable lens, including a polarization rotator, which has opposing first and second sides and is configured to rotate a polarization of light passing through the polarization rotator by 90°. First and second optical phase modulators are disposed respectively on the first and second sides of the polarization rotator. Each of the first and second optical phase modulators includes first and second transparent substrates in mutually parallel orientations and a liquid crystal layer contained between the first and second transparent substrates. A common electrode is disposed on the first transparent substrate, and an array of excitation electrodes, including parallel conductive stripes, is disposed on the second transparent substrate. An alignment layer disposed on an inner surface of at least the second transparent substrate contains linear alignment structures perpendicular to the conductive stripes and in contact with the liquid crystal layer. The conductive stripes in the second optical phase modulator are perpendicular to the conductive stripes in the first optical phase modulator.

In some embodiments, the lens includes control circuitry, which is configured to apply control voltage waveforms to the excitation electrodes, relative to the common electrode, so as to generate respective first and second cylindrical refractive profiles in the first and second optical phase modulators. In a disclosed embodiment, the control voltage waveforms are chosen so that the first and second cylindrical refractive profiles together provide a near-vision correction for a user of the lens. Additionally or alternatively, the first and second cylindrical refractive profiles have respective, first and second cylinder axes, which are mutually perpendicular, and the control circuitry is configured to adjust the control voltage waveforms so as to vary respective locations of the first and second cylinder axes. In a disclosed embodiment, the cylindrical refractive profiles include cylindrical Fresnel lens profiles.

Further additionally or alternatively, the lens includes a polarizer, which is adjacent to the first optical phase modulator and has a polarization axis parallel to the linear alignment structures of the first optical phase modulator.

There are also provided, in accordance with an embodiment of the invention, adaptive spectacles, which include a frame, including a front piece, which includes a nose bridge, and temples connected to respective edges of the front piece. Right and left electrically tunable lenses are mounted in the front piece. Each of the electrically tunable lenses includes a transparent envelope and at least one liquid crystal layer contained within the transparent envelope. An array of excitation electrodes is disposed on the transparent envelope. One or more control chips are mounted along an edge of the transparent envelope and are coupled to apply control voltage waveforms to the electrodes. A main controller circuit is disposed in one of the temples and configured to set an operating state of the electrically tunable lenses. A lens controller circuit is disposed in the nose bridge and configured to receive an indication from the main controller circuit of a change in the operating state and to output control signals to the one or more control chips to modify the control voltage waveforms in response to the indication.

In some embodiments, the spectacles include a user interface circuit disposed on the one of the temples and configured to sense a gesture made by a user of the spectacles, wherein the main controller circuit is configured to change the operating state of the electrically tunable lenses in response to the sensed gesture. In one embodiment, the user interface circuit includes one or more proximity sensors.

In a disclosed embodiment, the control voltage waveforms are chosen so that the electrically tunable lenses provide a near-vision correction for a user of the spectacles, and the lens controller circuit is configured to turn the near-vision correction on or off in response to the indication from the main controller circuit.

In some embodiments, the excitation electrodes include conductive stripes extending across the transparent envelope, and each of the one or more control chips includes an array of outputs, which are connected to a group of the conductive stripes, such that each output is connected to a respective one of the conductive stripes. In one embodiment, the conductive stripes include a first set of the stripes that extend vertically across the transparent envelope and a second set of the conductive stripes that extend horizontally across the transparent envelope, and the one or more control chips include at least a first control chip mounted along a horizontal edge of the transparent envelope and connected to the stripes in the first set and at least a second control chip mounted along a vertical edge of the transparent envelope and connected to the stripes in the second set.

Additionally or alternatively, the one or more control chips include at least first and second control chips, which are respectively connected to apply the control voltage waveforms to first and second groups of the excitation electrodes, and the first control chip is connected to receive first control signals directly from the lens controller circuit, while the second control chip is chained to the first control chip so as to receive second control signals via the first control chip from the lens controller circuit.

In a disclosed embodiment, the spectacles include communication circuitry coupled to the main controller circuit and configured to communicate over a wireless link with a mobile computing device in proximity to the adaptive spectacles.

There are additionally provided, in accordance with an embodiment of the invention, adaptive spectacles, which include a frame, including a front piece and temples connected to respective edges of the front piece, and right and left electrically tunable lenses mounted in the front piece. A user interface circuit includes a plurality of proximity sensors disposed on at least one of the temples and configured to output respective signals in response to proximity of a finger to each of proximity sensors. Control circuitry disposed in the frame is configured to apply control voltage waveforms to the electrically tunable lenses in order to set a refractive property of the electrically tunable lenses and to modify the control voltage waveforms in response to the respective signals output by two or more of the proximity sensors in a predefined time sequence.

In a disclosed embodiment, the control circuitry is configured to set the refractive property in response to a swipe gesture along the at least one of the temples, which causes at least two of the proximity sensors to output the respective signals sequentially such that a delay between the signals is within a predefined bound.

Additionally or alternatively, the plurality of the proximity sensors includes at least three proximity sensors disposed longitudinally along the at least one of the temples.

In one embodiment, the proximity sensors are disposed within the at least one of the temples.

There are further provided, in accordance with an embodiment of the invention, adaptive spectacles, which include a frame, including a front piece and temples connected to respective edges of the front piece, and right and left electrically tunable lenses mounted in the front piece. Communication circuitry disposed in the frame is configured to communicate over a wireless link with a mobile computing device in proximity to the adaptive spectacles. Control circuitry disposed in the frame is configured to apply control voltage waveforms to the electrically tunable lenses in order to set a refractive property of the electrically tunable lenses and to modify the control voltage waveforms in response to a command received over the wireless link by the communication circuitry from the mobile computing device.

In some embodiments, the command is generated by an application running on the mobile computing device and causes the control circuitry to change a refractive state of the lenses. In one embodiment, the command causes the control circuitry to modify the control voltage waveforms so as to adjust a refractive power of the electrically tunable lenses. Alternatively or additionally, the command causes the control circuitry to modify the control voltage waveforms so as to shift an optical axis of at least one of the electrically tunable lenses.

In some embodiments, the application running on the mobile computing device displays a calibration pattern on a screen of the mobile computing device, receives an input from a user wearing the adaptive spectacles while viewing the screen, and issues the command to modify the refractive property responsively to the input. In a disclosed embodiment, the application instructs the control circuitry to apply different sets of the control voltage waveforms to the electrically tunable lenses while the user views the screen and prompts the user to provide the input so as to select one of the sets.

Alternatively or additionally, the application running on the mobile computing device instructs the control circuitry to apply the control voltage waveforms to the electrically tunable lenses so as to blur light passing through selected areas of the electrically tunable lenses and to shift the selected areas in response to an input from a user wearing the adaptive spectacles.

There is moreover provided, in accordance with an embodiment of the invention, a method for producing an electrically tunable lens. The method includes providing first and second optical phase modulators, each including first and second transparent substrates in mutually parallel orientations and a liquid crystal layer contained between the first and second transparent substrates. A common electrode is disposed on the first transparent substrate, and an array of excitation electrodes, including parallel conductive stripes, is disposed on the second transparent substrate. An alignment layer is disposed on an inner surface of at least the second transparent substrate and contains linear alignment structures perpendicular to the conductive stripes and in contact with the liquid crystal layer. The first and second optical phase modulators are mounted respectively on opposing first and second sides of a polarization rotator, which is configured to rotate a polarization of light passing through the polarization rotator by 90°, such that the conductive stripes in the second optical phase modulator are perpendicular to the conductive stripes in the first optical phase modulator.

There is furthermore provided, in accordance with an embodiment of the invention, a method for producing adaptive spectacles. The method includes providing a frame, including a front piece, which includes a nose bridge, and temples connected to respective edges of the front piece. Right and left electrically tunable lenses are mounted in the front piece. Each of the electrically tunable lenses includes a transparent envelope, at least one liquid crystal layer contained within the transparent envelope, an array of excitation electrodes disposed on the transparent envelope, and one or more control chips, which are mounted along an edge of the transparent envelope and are coupled to apply control voltage waveforms to the electrodes. A main controller circuit is placed in one of the temples, and configured to set an operating state of the electrically tunable lenses. A lens controller circuit is placed in the nose bridge and configured to receive an indication from the main controller circuit of a change in the operating state and to output control signals to the one or more control chips to modify the control voltage waveforms in response to the indication.

There is also provided, in accordance with an embodiment of the invention, a method for producing adaptive spectacles. The method includes providing a frame, including a front piece and temples connected to respective edges of the front piece, and mounting right and left electrically tunable lenses in the front piece. A user interface circuit is placed on at least one of the temples. The user interface circuit includes a plurality of proximity sensors configured to output respective signals in response to proximity of a finger to each of proximity sensors. Control circuitry is placed in the frame and configured to apply control voltage waveforms to the electrically tunable lenses in order to set a refractive property of the electrically tunable lenses and to modify the control voltage waveforms in response to the respective signals output by two or more of the proximity sensors in a predefined time sequence.

There is additionally provided, in accordance with an embodiment of the invention, a method for producing adaptive spectacles. The method includes providing a frame, including a front piece and temples connected to respective edges of the front piece. Right and left electrically tunable lenses are mounted in the front piece. Communication circuitry is placed in the frame and configured to communicate over a wireless link with a mobile computing device in proximity to the adaptive spectacles. Control circuitry is placed in the frame and configured to apply control voltage waveforms to the electrically tunable lenses in order to set a refractive property of the electrically tunable lenses and to modify the control voltage waveforms in response to a command received over the wireless link by the communication circuitry from the mobile computing device.

The present invention will be more fully understood from the following detailed description of the embodiments thereof, taken together with the drawings in which:

### BRIEF DESCRIPTION OF THE DRAWINGS

FIG. 1 is a schematic pictorial illustration showing adaptive spectacles in use in accordance with an embodiment of the invention;

FIG. 2 is a schematic pictorial view of internal details of adaptive spectacles, in accordance with an embodiment of the invention;

FIG. 3 is a schematic sectional illustration of an optical phase modulator used in an electrically tunable lens, in accordance with an embodiment of the invention;

FIG. 4 is a schematic sectional illustration of an electrically tunable lens, in accordance with an embodiment of the invention;

FIG. 5 is a schematic pictorial view of user interface components in adaptive spectacles, in accordance with an embodiment of the invention; and

FIG. 6 is a flow chart that schematically illustrates a method for calibration of adaptive spectacles, in accordance with an embodiment of the invention.

### DETAILED DESCRIPTION OF EMBODIMENTS

### Overview

Presbyopia affects many adults over age 40 and becomes increasingly common with increasing age. People suffering from presbyopia must either use bifocal or multifocal glasses or put on reading glasses for near vision tasks. Thus, for example, during outdoor activities, a presbyope may find it necessary to switch frequently between wearing sunglasses for distant vision and wearing reading glasses to use a mobile phone. Multifocal lenses can be useful in solving this problem but limit the user's field of vision.

Spectacles with electrically tunable lenses offer a promising solution to the problems of presbyopia (as well as other defects of refraction of the eye). For such a solution to be practical, however, the spectacles must satisfy a range of difficult technical demands, such as manufacturability and durability, reasonable cost, light weight, low power consumption, and ease of use. The lenses and all the associated electronics should fit into a spectacle frame that is compact and stylish. Embodiments of the present invention that are described herein address these needs.

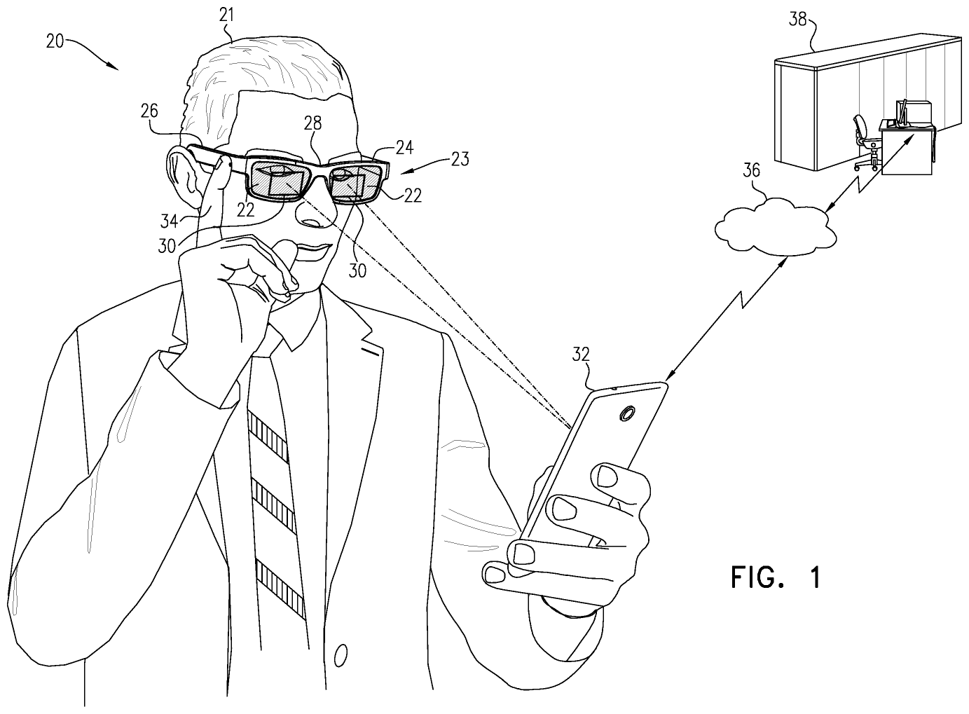

FIG. 1 is a schematic pictorial illustration showing adaptive spectacles 20 worn by a user 21, in accordance with an embodiment of the invention. Spectacles 20 comprise a frame 23, comprising a front piece 24, which includes a nose bridge 28, and temples 26 connected to respective edges of the front piece.

Right and left electrically tunable lenses 30 are contained in respective transparent envelopes 22, which are mounted in front piece 24. As long as lenses 30 are switched off, user 21 is able to see through the entire area of envelopes 22 without distortion (or possibly with a fixed refractive correction, such as a negative correction for myopia, for example). When lenses 30 are switched on, they provide a near-vision correction for user 21, typically by adding positive refractive power in the area of the lenses. Alternatively or additionally, lenses 30 may be controlled to correct other refractive defects, with positive or negative refractive power. In the pictured embodiment, envelopes 22 are tinted to serve as sunglasses, but the principles of the present invention are equally applicable to non-tinted glasses. Furthermore, although electrically tunable lenses 30 are shown in FIG. 1 as having a rectangular active area, which is located in the lower part of envelopes 22, in alternative embodiments the active areas of the electrically tunable lenses may have other shapes and locations and may even fill the entire area of envelopes 22.

To view a nearby object, such as the screen of a smartphone 32, user 21 turns on electrically tunable lenses 30. In the pictured example, user 21 turns on the lenses by performing a predefined gesture with a finger 34 against one of temples 26, such as a swiping or tapping gesture. Alternatively or additionally, user 21 may control spectacles 20 using a software application running on a mobile computing device, such as smartphone 32, which communicates with a controller circuit in the spectacles over a wireless link, such as a Bluetooth™ link. The application running on smartphone 32 may also communicate over a network 36, such as the Internet, with a server 38, for example in order to receive and install firmware updates for spectacles 20.

### Control Circuitry

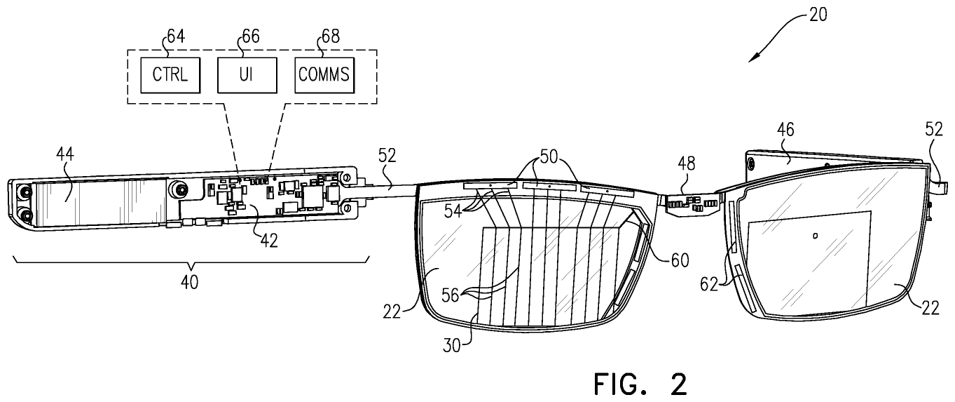

FIG. 2 is a schematic pictorial view of internal details of adaptive spectacles 20, in accordance with an embodiment of the invention. A control module 40, comprising a main controller circuit 42 and a rechargeable battery 44, is contained in one of temples 26. In the present example, an additional battery 46 is contained in the other temple, to extend the operating lifetime of the spectacles. A lens controller circuit 48 is contained in nose bridge 28 and communicates with control chips 50 and 62, which are mounted along the edges of transparent envelope 22.

Main controller circuit 42 and lens controller circuit 48 are connected by electrical traces, for example on a flexible printed circuit board 52 that runs inside the frame of spectacles. Lens controller circuit 48 is similarly connected to control chips 50 and 62 by electrical traces on one or more flexible circuit boards and/or electrical traces printed on envelope 22. This division of functions between main controller circuit 42 and lens controller circuit 48, along with the location of lens controller circuit 48 in nose bridge 28, is useful in reducing the numbers and lengths of the electrical traces running through the frame of spectacles 20. Flexible printed circuit board 52 passes through the hinge connecting temple 26 to front piece 24 and is therefore designed to bend precisely, with minimal stress, along the axis of rotation of the hinge.

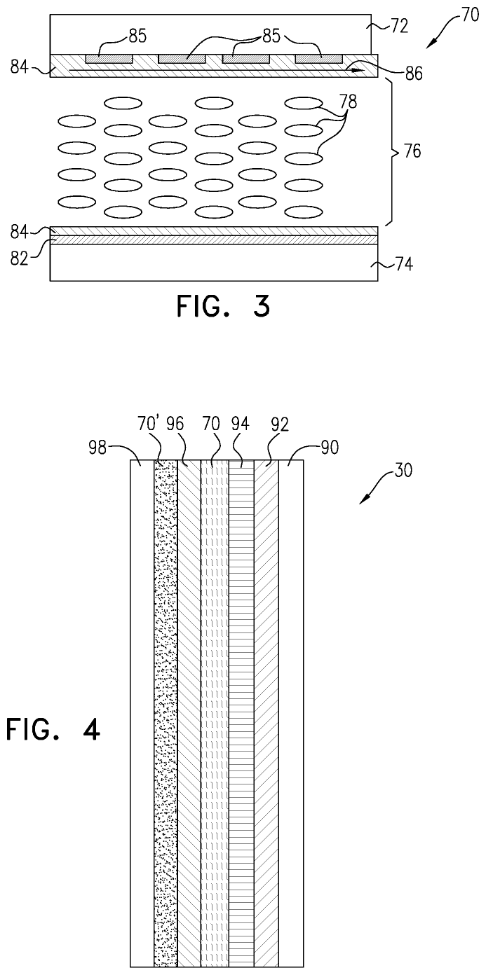

Tunable lenses 30 comprise at least one optical phase modulator comprising a liquid crystal layer (shown in FIG. 3), contained within transparent envelope 22. An array of excitation electrodes 56 runs across the transparent envelope. Typically, electrodes 56 comprise transparent conductive stripes, comprising indium tin oxide (ITO), for example. For the sake of clarity, only a small number of the stripes is shown in the figures; but in practice a much larger number of stripes, for example one thousand stripes or more, is used to enable fine control over the phase modulation profile of lens 30. Furthermore, although only one array, with stripes running in the vertical direction, is shown in FIG. 2, lens 30 typically comprises at least one additional array of conductive stripe electrodes, running in the horizontal direction. Details of the structure of lens 30 are shown in FIG. 4.

Control chips 50 have an array of outputs 54 connected respectively to electrodes 56 and apply control voltage waveforms through these outputs to the electrodes. Similarly, control chips 62 have outputs connected to the horizontal stripe electrodes of electrically tunable lens 30 (not shown in the figures). A common trace 60 connects to a common electrode (shown in FIG. 3), for example a uniform layer of ITO, which extends across the area of lens 30 on the opposite side of the liquid crystal layer from the stripe electrodes. The control voltage waveforms that are applied to electrodes 56 modulate the local effective index of refraction of the liquid crystal layers in lens 30 and thus generate a phase modulation profile that provides the desired refractive vision correction, for example a near-vision correction. Details of this functionality are described further hereinbelow, as well as in the PCT international publications that are cited above in the Background section (for example as shown in FIGS. 3A and 3B of PCT International Publication WO 2017/216716 and as described in the specification with reference to these figures).

Main controller circuit 42 sets the operating state of electrically tunable lenses 30 and outputs an indication of the operating state (and changes in the operating state) to lens controller circuit 48. In response to this indication, lens controller circuit 48 outputs control signals to control chips 50 and 62 to modify the control voltage waveforms that are applied to electrodes 56.

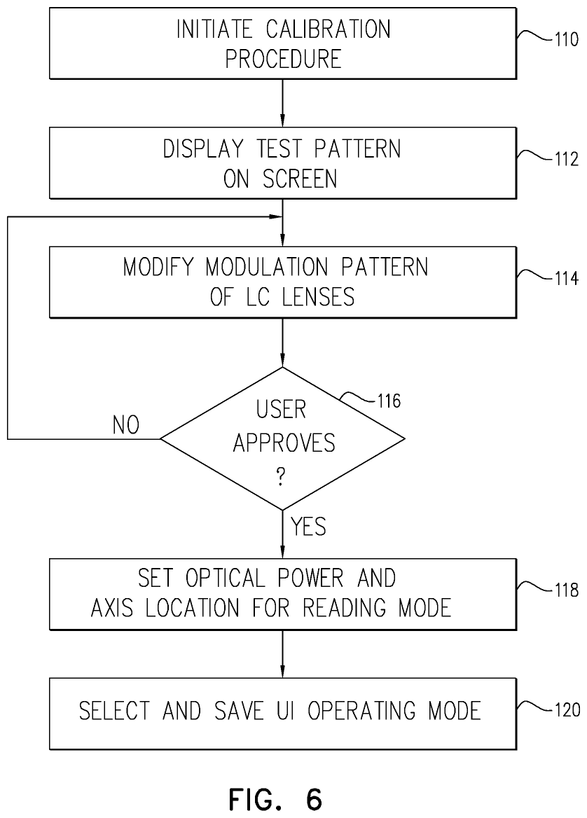

In the example shown in FIG. 2, multiple control chips 50 are mounted along a horizontal edge of envelope 22, and multiple control chips 62 are mounted along a vertical edge of the envelope, in order to provide sufficient numbers of outputs 54 to drive all the electrodes. To reduce the numbers and lengths of interconnections that are required between lens controller circuit 48 and control chips 50 and 62, only the first control chip along each edge is connected to receive control signals directly from the lens controller circuit. The second and subsequent control chips are chained to the first control chip so as to receive their respective control signals via the first control chip from lens controller circuit 48. A scheme of this sort for chaining of control chips is shown in FIGS. 6-8 of the above-mentioned PCT International Publication WO 2017/216716 and is described in the specification with reference to these figures.

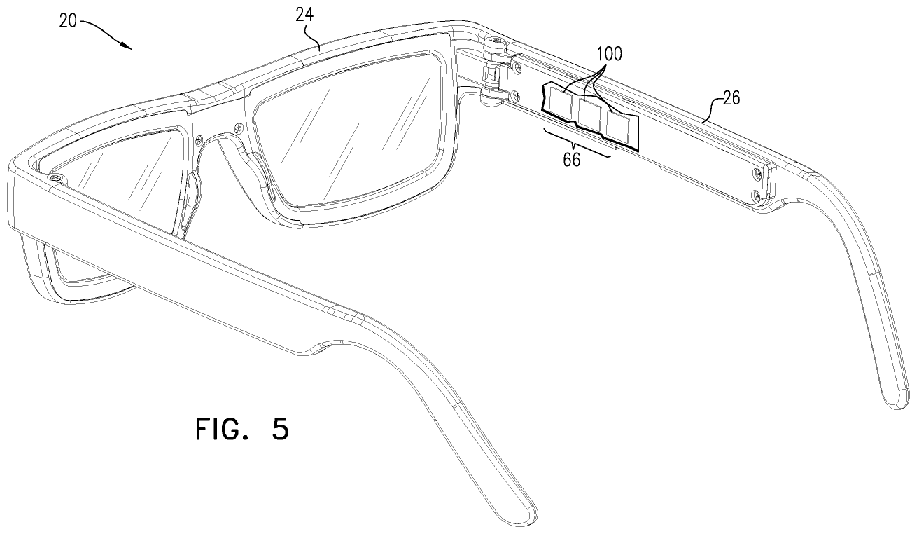

Main controller circuit 42 comprises a microcontroller 64, which runs under the control of firmware and controls all components of spectacles 20. For example, microcontroller 64 can instruct lens controller circuit 48 to turn the near-vision correction applied by electrically tunable lenses 30 on and off, as well as changing refractive parameters of the lenses 30, such as the refractive powers (focal length) and the locations of the optical axes of the lenses. Microcontroller 64 receives inputs from a user interface circuit 66, which is disposed on one or both temples 26 and senses gestures made by user 21 against the temple, thus enabling the user to change the operating state of electrically tunable lenses 30. (The user interface circuit is described below in greater detail with reference to FIG. 5.) Main controller circuit 42 may comprise other components, as well, such as indicator lights and an inertial measurement unit (IMU), and may carry out other functions in addition to those described herein.

Microcontroller 64 is also coupled to wireless communication circuitry 68, such as a Bluetooth™ interface, for communication with smartphone 32 and/or other computing devices in order to receive firmware updates and configuration and calibration instructions. Thus, an application running on smartphone 32 may instruct microcontroller 64 to modify the control voltage waveforms that are applied to electrically tunable lenses 30. Such a modification, for example, may cause the control circuitry in spectacles 20 to turn lenses 30 on or off or otherwise change the refractive state of the lenses. Additionally or alternatively, such instructions may cause the control circuitry to adjust the refractive power of electrically tunable lenses 30 or to shift the optical axis of at least one of the electrically tunable lenses.

### Electrically Tunable Lenses

FIG. 3 is a schematic sectional view of an optical phase modulator 70 used in electronically tunable lens 30, in accordance with an embodiment of the invention. Optical phase modulator 70 comprises an electro-optical layer 76, sandwiched between a first substrate 74 and a second substrate 72, which comprise a transparent material, for example, glass. Layer 76 comprises a liquid crystal material, which is typically contained by suitable encapsulation, as is known in the art.

Substrates 72 and 74 are coated on their insides with a polyimide alignment layer 84 (for example PI-2555, produced by Nissan Chemical Industries Ltd., Japan). Layer 84 is rubbed to create linear alignment structures in contact with layer 76, which cause liquid crystal molecules 78 to line up in a desired parallel orientation. The linear alignment structures can comprise actual physical grooves in alignment layer 84, for example, or alternatively molecular structures in the alignment layer that exert electrical aligning forces on the liquid crystal molecules. The rubbing direction is illustrated by an arrow 86. It may be advantageous to rub alignment layer 84 on substrate 74 in a direction opposite (antiparallel) to the rubbing direction on substrate 72 that is shown by arrow 86.

Conductive electrodes 82 and 85 are disposed over opposing first and second sides of electro-optical layer 76. Electrodes 82 and 85 comprise a transparent, conductive material, such as indium tin oxide (ITO), which is deposited on the surfaces of substrates 74 and 72, respectively. Although for the sake of visual clarity, only a few electrodes 85 are shown in FIG. 3, in practice, for good optical quality, optical phase modulator 70 will typically comprise hundreds of stripe electrodes for excitation, and possibly a thousand or several thousand stripe electrodes. The electrodes are typically produced by film deposition and photolithographic processes.

Electrodes 85 in the pictured embodiment are arranged as an array of parallel stripes. On the opposite side of layer 76, electrode 82 comprises a uniform layer on substrate 44, defining a common electrode capable of serving as an electrical ground plane. This arrangement of electrodes enables control chips 50 and 62 (FIG. 2) to apply control voltage waveforms to electrodes 85, relative to electrode 82, so that optical phase modulator 70 creates a refractive phase modulation profiles equivalent to a cylindrical lens. Two such optical phase modulators 70 in series, with electrodes 85 oriented orthogonally one to the other, can be used in lens 30 to generate cylindrical refractive profiles with mutually perpendicular cylinder axes, which can thus emulate two-dimensional optical modulation profiles. As noted earlier, the two-dimensional profile can be chosen to provide a near-vision correction for a user of lens 30 (or another refractive correction). Furthermore, control chips 50 and 62 may be driven to adjust the control voltage waveforms so as to vary the respective locations of the cylinder axes, and thus shift the optical center of lens 30, for example to align with the user's pupil.

As explained earlier, due to the behavior of liquid crystal molecules 78, electro-optical layer 76 has an effective local index of refraction at any given location that is determined by the voltage waveform that is applied across the electro-optical layer at that location. When used in spectacles, such as in lens 30, the phase modulation profile is chosen to cause rays of optical radiation that are incident on optical phase modulator 70 to converge or diverge with a desired focal power. For strong focal power, the phase modulation profile may comprise a cylindrical Fresnel profile, with sharp peaks and troughs. Alternatively or additionally, the control voltage waveforms may be chosen so as to give rise to a smooth refractive phase modulation profile. Further details of the control voltage waveforms that may be applied to such electrodes in order to generate various sorts of phase modulation profiles, are described in the above-mentioned PCT International Publications WO 2014/049577 and WO 2015/186010.

Because of the polarization-dependent properties of liquid crystal molecules 78, optical phase modulator 70 will modulate the phase only of light that is polarized parallel to the molecules, i.e., along the direction indicated by arrow 86. Light polarized in the orthogonal direction passes through electro-optical layer 76 without modulation. The rubbing direction of alignment layer 84 in optical phase modulator 70 is perpendicular to the stripe direction of electrodes 85, meaning that the optical phase modulator modulates light that is polarized perpendicular to the stripe direction.

The reason for this choice of polarization direction is that the phase modulation of light passing through electrically tunable lens 30 at any given point depends on both the voltage applied at that point and the incidence angle of the light (as well as other factors, such as the voltages of neighboring electrodes). The incidence angle to be considered in this case is a function of the distance of the given point on lens 30 from the center of the user's eye. These considerations regarding the incidence angle, as well as the adjustment of the voltages applied to the electrodes in order to compensate for the incidence angle, are explained in greater detail in the above-mentioned PCT International Publication WO 2017/182906 (particularly in references to FIGS. 3, 4, 5 and 6A/B). Electrodes 85 in optical phase modulator 70 are oriented perpendicularly to the rubbing direction, and thus to the polarization of the light that is to be focused, in order to facilitate effective compensation for these variations of incidence angle.

FIG. 4 is a schematic sectional illustration of electrically tunable lens 30, in accordance with an embodiment of the invention. Lens 30 comprises two optical phase modulators 70 and 70′, both of which are configured as shown in FIG. 3, while the direction of electrodes 85 in optical phase modulator 70′ is rotated by 90° relative to optical phase modulator 70. For example, electrodes 85 in optical phase modulator 70 may be oriented horizontally, while those in optical phase modulator 70′ are oriented vertically. Thus, as explained above, the cylindrical phase modulation profiles applied by modulators 70 and 70′, with horizontal and vertical cylinder axes, respectively, can be combined to emulate a spherical or other two-dimensional profile and provide the desired refractive correction for the user.

Because of the respective rubbing directions, however, optical phase modulator 70 modulates only light having a vertical polarization, while optical phase modulator 70′ modulates only light having a horizontal polarization. To overcome this problem, a polarization rotator 96 is interposed between optical phase modulators 70 and 70′, with one of the optical phase modulators on each of side. Polarization rotator 96 comprises a wideband half-wave plate, for example, which rotates the polarization of incident light passing through the polarization rotator by 90°.

By virtue of polarization rotator 96, optical phase modulators 70 and 70′ will both modulate light that is incident on modulator 70 with vertical polarization. On the other hand, light with horizontal polarization will pass through without modulation. To block this unmodulated polarization component, lens 30 comprises a polarizer 94, which is positioned adjacent to optical phase modulator 70. For example, polarizer 94 may comprise a polarizing film on the front side of optical phase modulator 70 or on another surface of lens 30, with a vertical polarization axis (as in conventional polarized sunglasses). The polarization of polarizer 94, in other words, is parallel to the linear alignment structures of alignment layer 84 in optical phase modulator 70.

Electrically tunable lens 30 also comprises a spectral filter 92, which blocks ultraviolet light and may also attenuate certain wavelength ranges of the visible spectrum. This sort of range blocking can be particularly beneficial when optical phase modulators 70 and 70′ are driven to generate Fresnel lens profiles. As explained in PCT International Publication WO 2019/135168, whose disclosure is incorporated herein by reference, a Fresnel lens typically has a high modulation transfer function (MTF) for wavelengths that are integer multiples of the height of the phase steps in the Fresnel lens and lower MTF at other wavelengths. Thus, in an embodiment of the present invention, spectral filter 92 is designed to pass light in two or more visible wavelength bands that are centered on wavelengths of peak MTF of the Fresnel lens profiles generated by optical phase modulators 70 and 70′, and to attenuate visible light outside these passbands. For example, filter 92 may have passbands around 530 nm and 630 nm, while blocking wavelengths around 580 nm. Filter 92 can be implemented using thin-film reflective coatings and/or dyes that selectively absorb certain wavelengths.

The optical components of electrically tunable lens 30 are encapsulated in a transparent envelope comprising protective layers 90 and 98, which are positioned on both sides of the lens. Layers 90 and 98 typically comprise a suitable polymer. Spectral filter 92, as well as polarizer 94, may be deposited on one or both of these layers. Alternatively or additionally, spectral filter 92 may be implemented by a dye mixed into the polymer material of one or both of layers 90 and 98. Further additionally or alternatively, an anti-reflection coating may be applied to the outer surface of one or both of layers 90 and 98.

Layers 90 and 98 can be flat on both sides, as shown in FIG. 4. Alternatively, layers 90 and 98 may be curved. For example, layer 90 can be plano-convex, while layer 98 is plano-concave, with inverse optical power to layer 90 or with a different optical power to provide a far-vision correction. For example, layers 90 and/or 98 may be produced with curved surfaces to match the user's prescription for far-vision correction.

The components of electrically tunable lens 30 are typically laminated together using a suitable optical adhesive. Although for the sake of clarity, FIG. 4 shows the components and layers of electrically tunable lens 30 in a certain sequence, identical or similar effects can be obtained using different sequences of these components and layers. These alternative sequences will be apparent to those skilled in the art after reading the present description and are considered to be within the scope of the present invention.

### Control and Calibration of Adaptive Spectacles

FIG. 5 is a schematic pictorial view of components of user interface circuit 66 in adaptive spectacles 20, in accordance with an embodiment of the invention. User interface circuit 66 comprises multiple proximity sensors 100 on one or both of temples 26 of spectacles 20. In the pictured example, three proximity sensors 100 are disposed longitudinally within temple 26. Main controller circuit 42 will respond when two or more of proximity sensors 100 output signals in a predefined time sequence. This arrangement and interface protocol are useful in reliably detecting a variety of gestures made by the user's finger, such as multi-tap and swipe gestures along temple 26, while rejecting inadvertent user interface signals that can result from spurious contact with the spectacles.

Proximity sensors 100 output respective signals in response to the proximity of a finger to each of proximity sensors. For example, proximity sensors 100 may comprise capacitive sensors, which measure the capacitance change when a finger (or other object) contacts temple 26 in close proximity to the sensor. Alternatively, any other suitable type of proximity sensors may be used, such as optical sensors or pressure sensors. Although the linear arrangement shown in FIG. 5 has been found to give good results, user interface circuit 66 may alternatively comprises a larger or smaller number of proximity sensors, either in a longitudinal row as shown in the figure or in a different geometrical arrangement.

Main controller circuit 42 sets and changes the control voltage waveforms that are applied to electrically tunable lenses 30 in response to certain time sequences of the signals output by proximity sensors 100. For example, a swipe gesture along temple 26 will cause at least two of the proximity sensors (and typically all three proximity sensors) to output signals sequentially within certain bounds of the delay between the respective signals. In one mode of operation, a forward swipe along temple 26 turns electrically tunable lenses 30 on, to facilitate near vision, while a backward swipe turns the lenses off. Alternatively or additionally, multiple finger taps can be used to turn the lenses on or off. Further alternatively or additionally, these and other gestures can be used to control other functions of spectacles 20.

FIG. 6 is a flow chart that schematically illustrates a method for calibration of adaptive spectacles 20, in accordance with an embodiment of the invention. This method can be carried out, for example, in the system configuration illustrated in FIG. 1, using an application running on smartphone 32. The calibration procedure is used to set the refractive properties of electrically tunable lenses 30, including the optical powers and optical centers of the lenses. Thus, this calibration can include defining the best positions to place the optical axes of electrically tunable lenses 30 when they are turned on, which depends on the inter-pupillary distance of the user and on the way the frame is mounted on the user's head. Alternatively or additionally, the calibration process can include determining the optical power the user requires for reading.

User 21 initiates the calibration procedure by putting on glasses 20 and opening the application on smartphone 32, at an initiation step 110. Smartphone 32 displays a test pattern on its display screen, at a calibration display step 112. The test pattern may comprise, for example, small text characters or other symbols suitable for evaluating the user's near vision. The application on smartphone 32 issues instructions to main controller circuit 42 in spectacles 20 (FIG. 2) to apply different sets of the control voltage waveforms to electrically tunable lenses 30 while the user views the screen, at a lens modification step 114. For example, the waveforms may be modified to step through a number of different settings of the refractive power and of the locations of the optical axes of the lenses.

Alternatively or additionally, the waveforms may define areas of lenses 30 that are effectively opaque, along with other areas that are clear, to identify the position in each lens through which the user is looking. The instructions are typically conveyed via the wireless link between smartphone 32 and spectacles 20. Main controller circuit 42 can render an area of lenses 30 effectively opaque, for example, by applying control voltage waveforms that vary rapidly across the area in such a way that light passing through these areas is strongly scattered, and images seen through these areas are therefore blurred. In one embodiment, the application running on smartphone 32 instructs the main controller circuit to make the entire area of lens 30 effectively opaque except for a narrow stripe. The user moves this narrow stripe across the area of lens 30, for example by sliding a finger across the touchscreen of the smartphone, and is thus able to find and identify the position of the stripe that is most comfortable for purposes of reading. This position will subsequently be used as the optical center when lens 30 is actuated for near vision.

The application running on smartphone 32 prompts the user to select the settings that provide the best conditions for reading the test pattern on the display screen. The application continues applying different settings until the user provides an input indicating the preferred settings, at a user approval step 116. The application conveys the user's selection via the wireless link to main controller circuit 42, indicating the optical power and optical axis location to be used when the user selects the near-vision reading mode, at a setting input step 118.

The user can also use the application on smartphone 32 to select other features and parameters of spectacles 20. For example, the user may choose which gestures will turn the reading mode on and off, as well as setting power saving and other user interface features, at a mode selection step 120.

Once the calibration has been completed at step 118 and other operating parameters have been selected at step 120, application on smartphone 32 conveys the settings to main controller circuit 42, which then saves the settings in local memory. The wireless link between spectacles 20 and smartphone 32 can then be disconnected, and spectacles 20 will operate autonomously in accordance with the selected settings.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An electrically tunable lens, comprising:
a polarization rotator, which has opposing first and second sides and is configured to rotate a polarization of light passing through the polarization rotator by 90°; and
first and second optical phase modulators disposed respectively on the first and second sides of the polarization rotator, each of the first and second optical phase modulators comprising:
first and second transparent substrates in mutually parallel orientations;
a liquid crystal layer contained between the first and second transparent substrates;
a common electrode disposed on the first transparent substrate;
an array of excitation electrodes, comprising parallel conductive stripes, disposed on the second transparent substrate; and
an alignment layer disposed on an inner surface of at least the second transparent substrate and containing linear alignment structures perpendicular to the conductive stripes and in contact with the liquid crystal layer,
such that the conductive stripes in the second optical phase modulator are perpendicular to the conductive stripes in the first optical phase modulator.

2. The lens according to claim 1, and comprising control circuitry, which is configured to apply control voltage waveforms to the excitation electrodes, relative to the common electrode, so as to generate respective first and second cylindrical refractive profiles in the first and second optical phase modulators.

3. The lens according to claim 2, wherein the control voltage waveforms are chosen so that the first and second cylindrical refractive profiles together provide a near-vision correction for a user of the lens.

4. The lens according to claim 2, wherein the first and second cylindrical refractive profiles have respective, first and second cylinder axes, which are mutually perpendicular, and wherein the control circuitry is configured to adjust the control voltage waveforms so as to vary respective locations of the first and second cylinder axes.

5. The lens according to claim 2, wherein the cylindrical refractive profiles comprise cylindrical Fresnel lens profiles.

6. The lens according to claim 1, and comprising a polarizer, which is adjacent to the first optical phase modulator and has a polarization axis parallel to the linear alignment structures of the first optical phase modulator.

7-18. (canceled)

19. Adaptive spectacles, comprising:
a frame, comprising a front piece and temples connected to respective edges of the front piece;
right and left electrically tunable lenses mounted in the front piece;
communication circuitry disposed in the frame and configured to communicate over a wireless link with a mobile computing device in proximity to the adaptive spectacles; and
control circuitry disposed in the frame and configured to apply control voltage waveforms to the electrically tunable lenses in order to set a refractive property of the electrically tunable lenses and to modify the control voltage waveforms in response to a command received over the wireless link by the communication circuitry from the mobile computing device.

20. The spectacles according to claim 19, wherein the command is generated by an application running on the mobile computing device and causes the control circuitry to change a refractive state of the lenses.

21. The spectacles according to claim 20, wherein the command causes the control circuitry to modify the control voltage waveforms so as to adjust a refractive power of the electrically tunable lenses.

22. The e spectacles according to claim 20, wherein the command causes the control circuitry to modify the control voltage waveforms so as to shift an optical axis of at least one of the electrically tunable lenses.

23. The spectacles according to claim 20, wherein the application running on the mobile computing device displays a calibration pattern on a screen of the mobile computing device, receives an input from a user wearing the adaptive spectacles while viewing and issues the command to modify the refractive property responsively to the input.

24. The spectacles according to claim 23, wherein the application instructs the control circuitry to apply different sets of the control voltage waveforms to the electrically tunable lenses while the user views the screen and prompts the user to provide the input so as to select one of the sets.

25. The spectacles according to claim 20, wherein the application running on the mobile computing device instructs the control circuitry to apply the control voltage waveforms to the electrically tunable lenses so as to blur light passing through selected areas of the electrically tunable lenses and to shift the selected areas in response to an input from a user wearing the adaptive spectacles.

26. A method for producing an electrically tunable lens, the method comprising:
providing first and second optical phase modulators, each comprising:
first and second transparent substrates in mutually parallel orientations;
a liquid crystal layer contained between the first and second transparent substrates;
a common electrode disposed on the first transparent substrate;
an array of excitation electrodes, comprising parallel conductive stripes, disposed on the second transparent substrate; and
an alignment layer disposed on an inner surface of at least the second transparent substrate and containing linear alignment structures perpendicular to the conductive stripes and in contact with the liquid crystal layer; and
mounting the first and second optical phase modulators respectively on opposing first and second sides of a polarization rotator, which is configured to rotate a polarization of light passing through the polarization rotator by 90°, such that the conductive stripes in the second optical phase modulator are perpendicular to the conductive stripes in the first optical phase modulator.

27. The method according to claim 26, and comprising applying control voltage waveforms to the excitation electrodes, relative to the common electrode, so as to generate respective first and second cylindrical refractive profiles in the first and second optical phase modulators.

28. The method according to claim 27, wherein the control voltage waveforms are chosen so that the first and second cylindrical refractive profiles together provide a near-vision correction for a user of the lens.

29. The method according to claim 27, wherein the first and second cylindrical refractive profiles have respective, first and second cylinder axes, which are mutually perpendicular, and wherein applying the control voltage waveforms comprises adjusting the control voltage waveforms so as to vary respective locations of the first and second cylinder axes.

30. The method according to claim 27, wherein the cylindrical refractive profiles comprise cylindrical Fresnel lens profiles.

31. The method according to claim 26, and comprising placing a polarizer adjacent to the first optical phase modulator with a polarization axis parallel to the linear alignment structures of the first optical phase modulator.

32-50. (canceled)
